(19) United States
(12) Patent Application Publication
(10) Pub. No.: US 2026/0175823 A1
(43) Pub. Date: Jun. 25, 2026

(54) BRAKING CONTROL DEVICE FOR VEHICLE

(71) Applicant: ADVICS CO., LTD., Kariya-shi, Aichi-ken (JP)

(72) Inventors: Takashi EBINE, Kariya-shi, Aichi-ken (JP); Shunya WATANABE, Kariya-shi, Aichi-ken (JP)

(73) Assignee: ADVICS CO., LTD., Kariya-shi, Aichi-ken (JP)

(21) Appl. No.: 18/840,272

(22) PCT Filed: Mar. 10, 2023
(86) PCT No.: PCT/JP2023/009433

§ 371 Date: Aug. 21, 2024

(30) Foreign Application Priority Data
Mar. 10, 2022 (JP) 2022-036960

(51) Int. Cl. B60T 8/176; B60T 13/68; B60T 13/74

(52) U.S. Cl. CPC B60T 8/176; B60T 13/686; B60T 13/745

(57) ABSTRACT

A braking control device for a vehicle includes “an upper braking unit configured to output a supply pressure by throttling, with a pressure adjustment valve, a circulation flow discharged by a fluid pump driven by an electric motor”, and “a lower braking unit disposed between the upper braking unit and a wheel cylinder and configured to adjust the supply pressure to output a wheel pressure to the wheel cylinder”. When the lower braking unit executes an antilock brake control, the upper braking unit increases a rotation number of the electric motor.

### TECHNICAL FIELD

The present disclosure relates to a braking control device for a vehicle.

### BACKGROUND ART

PTL 1 describes a liquid pressure control unit that realizes compatibility of control accuracy and response of a control of liquid pressures at wheel brakes by adopting a concept of a flow rate control. In PTL 1, a controller obtains target liquid amounts for the wheel brakes based on target liquid pressures, and obtains actual liquid amounts of the wheel brakes based on the liquid pressures detected by a braking liquid pressure detection unit. Then, target flow rates for the wheel brakes are obtained based on the target liquid amounts and the actual liquid amounts, and an operation of the liquid pressure control unit is controlled based on the target flow rates.

The applicant has developed a braking control device as described in PTL 2. The device in PTL 2 includes two components, that is, upper and lower braking units. In the upper braking unit, a braking liquid discharged by a fluid pump driven by an electric motor is adjusted to an adjustment liquid pressure (also referred to as a “servo pressure”). An input liquid pressure (also referred to as a “supply pressure”) adjusted by the adjustment liquid pressure is transmitted as a wheel pressure to a wheel cylinder via the lower braking unit. Although an antilock brake control is executed by the lower braking unit, a situation may occur in which performance of the antilock brake control is inadequate. A braking control device is required to deal with the above situation.

### CITATION LIST

### Patent Literature

PTL 1: JP 2008-296704A

PTL 2: JP 2019-059294A

### SUMMARY

### Technical Problem

An object of the present disclosure is to provide a braking control device for a vehicle which includes two braking units and can improve performance of an antilock brake control.

### Solution to Problem

A braking control device (SC) for a vehicle according to the present disclosure includes “an upper braking unit (SA) configured to output a supply pressure (Pm) by throttling, with a pressure adjustment valve (UA), a circulation flow (KN) discharged by a fluid pump (QA) driven by an electric motor (MA)”, and “a lower braking unit (SB) disposed between the upper braking unit (SA) and a wheel cylinder (CW) and configured to adjust the supply pressure (Pm) to output a wheel pressure (Pw) to the wheel cylinder (CW) ”. When the lower braking unit (SB) executes an antilock brake control, the upper braking unit (SA) increases a rotation number (Na) of the electric motor (MA). According to the above configuration, when the antilock brake control is executed by the lower braking unit SB, an amount of braking liquid supplied from the upper braking unit SA to the lower braking unit SB is increased, thereby improving performance of the antilock brake control.

In the braking control device (SC) for a vehicle according to the present disclosure, the upper braking unit (SA) determines an increase amount (Nz) of the rotation number (Na) based on an increase gradient (kP) of the wheel pressure (Pw) in the antilock brake control. According to the above configuration, the rotation number Na of the electric motor MA is increased only by an amount necessary to execute the antilock brake control. Accordingly, in addition to improving the performance of the antilock brake control, power consumption of the electric motor MA of the upper braking unit SA is decreased.

### BRIEF DESCRIPTION OF DRAWINGS

FIG. 1 is a schematic diagram for illustrating an overall configuration of a vehicle JV equipped with a braking control device SC according to the present disclosure.

FIG. 2 is a schematic diagram for illustrating a configuration example of an upper braking unit SA.

FIG. 3 is a schematic diagram for illustrating a configuration example of a lower braking unit SB.

FIG. 4 is a block diagram for illustrating a drive control of a pressure adjustment valve UA.

FIG. 5 is a block diagram for illustrating a drive control of an upper electric motor MA.

### DESCRIPTION OF EMBODIMENTS

### Symbols of Constituent Members or the like and Subscripts at the End of Symbols

In the following description, constituent members, calculation processing, signals, characteristics, and values denoted by the same symbols, such as “CW”, have the same function. Subscripts “f” and “r” added to the end of the symbols related to respective wheels are comprehensive symbols indicating which system of the front and rear wheels these subscripts relate to. For example, wheel cylinders CW provided in wheels are expressed as a “front wheel cylinder CWf” and a “rear wheel cylinder CWr”. Furthermore, the subscripts “f” and “r” at the end of the symbols can be omitted. When the subscripts “f” and “r” are omitted, each symbol represents a generic term. For example, “CW” is a generic term for wheel cylinders provided in front and rear wheels of a vehicle.

In a fluid passage from a master cylinder CM to the wheel cylinders CW, a side close to the master cylinder CM (a side far from the wheel cylinders CW) is referred to as an “upper portion”, and a side close to the wheel cylinders CW (a side far from the master cylinder CM) is referred to as a “lower portion”. In circulation flows KN, KL of a braking liquid BF, a side close to discharge portions of fluid pumps QA, QB (a side away from suction portions) is referred to as an “upstream side”, and a side close to the suction portions of the fluid pumps QA, QB (a side away from the discharge portions) is referred to as a “downstream side”.

An upper actuator YA (also referred to as an “upper fluid unit”) of an upper braking unit SA, a lower actuator YB (also referred to as a “lower fluid unit”) of a lower braking unit SB, and the wheel cylinders CW are connected by the fluid passage (a communication passage HS). Furthermore, in the upper and lower actuators YA, YB, various components (UA and the like) are connected by the fluid passage. Here, the “fluid passage” is a passage for moving the braking liquid BF, and includes piping, a flow passage in an actuator, a hose, and the like. In the following description, the communication passage HS, a reflux passage HK, a return passage HL, a reservoir passage HR, an input passage HN, a servo passage HV, a depressurization passage HG, and the like are fluid passages.

### Vehicle JV Equipped With Braking Control Device SC

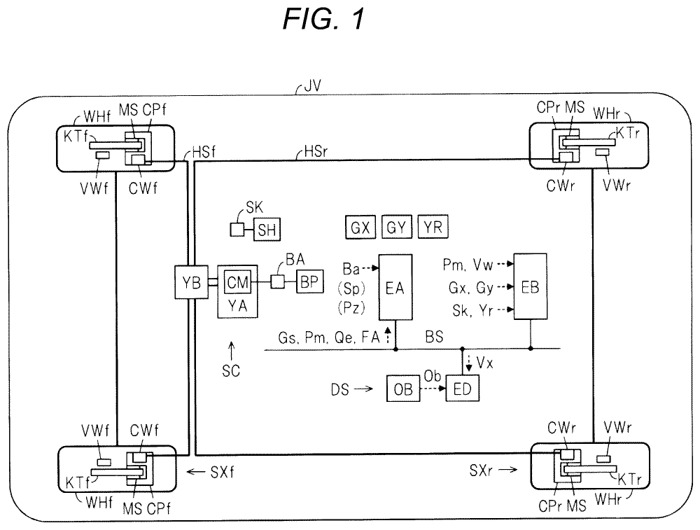

An overall configuration of a vehicle JV equipped with a braking control device SC according to the present disclosure will be described with reference to a schematic diagram of FIG. 1. The vehicle JV is provided with a driving assistance device DS in such a manner that a control (referred to as an “automatic braking control”) for automatically decelerating and stopping the vehicle is executed via the braking control device SC instead of a driver or by assisting the driver. The driving assistance device DS includes a distance sensor OB and a control unit ED (also referred to as a “driving assistance controller”) for the driving assistance device. A distance Ob (a relative distance) between an object (another vehicle, a fixed object, a person, a bicycle, a stop line, a sign, a signal, or the like) existing in front of the own vehicle JV and the own vehicle JV is detected by the distance sensor OB, and is input to the driving assistance controller ED. In the driving assistance controller ED, a required deceleration Gs for automatically stopping the vehicle JV is calculated based on the relative distance Ob. The required deceleration Gs is a target value of a vehicle deceleration for executing the automatic braking control. The required deceleration Gs is output to a communication bus BS.

The vehicle JV includes front wheel and rear wheel braking devices SXf, SXr (=SX). The braking device SX includes a brake caliper CP, a friction member MS (for example, a brake pad), and a rotating member KT (for example, a brake disc). The brake caliper CP is provided with the wheel cylinder CW. Due to a liquid pressure Pw (referred to as “wheel pressure”) in the wheel cylinder CW, the friction member MS is pressed against the rotating member KT fixed to each wheel WH. Accordingly, a friction braking force Fm is generated in the wheel WH. The “friction braking force Fm” is a braking force generated by the wheel pressure Pw.

The vehicle JV includes a braking operation member BP and a steering operation member SH. The braking operation member BP (for example, a brake pedal) is a member operated by the driver to decelerate the vehicle JV. The steering operation member SH (for example, a steering wheel) is a member operated by the driver to turn the vehicle JV.

The vehicle JV includes various sensors (BA and the like) listed below. Detection signals (Ba and the like) of these sensors are input to controllers EA, EB and used for various controls.
A braking operation amount sensor BA that detects an operation amount Ba (referred to as a braking operation amount) of the braking operation member BP is provided. For example, an operation displacement sensor SP that detects an operation displacement Sp of the braking operation member BP is provided as the braking operation amount sensor BA. In addition, a simulator pressure sensor PZ that detects a liquid pressure Pz (referred to as a “simulator pressure”) of a stroke simulator SS is employed. In the braking control device SC, the braking operation amount Ba is a generic term for signals indicating a braking intention of the driver, and the braking operation amount sensor BA is a generic term for sensors that detect the braking operation amount Ba. The braking operation amount Ba is input to the upper controller EA.
A wheel speed sensor VW that detects a rotation speed Vw (a wheel speed) of the wheel WH is provided. The wheel speed Vw is input to the lower controller EB. In the lower controller EB, a vehicle body speed Vx is calculated based on the wheel speed Vw. Furthermore, in the lower controller EB, based on the wheel speed Vw and the vehicle body speed Vx, an antilock brake control for preventing the wheels WH from being locked and a traction control for preventing idling of the drive wheel WH are executed.
A steering operation amount sensor SK that detects an operation amount Sk (a steering operation amount, for example, a steering angle) of the steering operation member SH is provided. The vehicle JV (in particular, a vehicle body) is provided with a yaw rate sensor YR that detects a yaw rate Yr, a longitudinal acceleration sensor GX that detects a longitudinal acceleration Gx, and a lateral acceleration sensor GY that detects a lateral acceleration Gy. These sensor signals are input to the lower controller EB. In the lower controller EB, oversteer and understeer are prevented, and an electronic stability control (ESC) for stabilizing a yawing behavior of the vehicle JV is executed.

The vehicle JV includes the braking control device SC. In the braking control device SC, a front-rear type (also referred to as “II type”) is adopted for the braking system including two systems. The actual wheel pressure Pw is adjusted by the braking control device SC.

The braking control device SC includes the two braking units SA, SB. The upper braking unit SA includes the upper actuator YA (the upper fluid unit) and the upper controller EA (an upper control unit). The upper actuator YA is controlled by the upper controller EA. The lower braking unit SB is disposed between the upper braking unit SA and the wheel cylinder CW. The lower braking unit SB includes the lower actuator YB (the lower fluid unit) and the lower controller EB (a lower control unit). The lower actuator YB is controlled by the lower controller EB.

The upper braking unit SA (in particular, the upper controller EA), the lower braking unit SB (in particular, the lower controller EB), and the driving assistance device DS (in particular, the driving assistance controller ED) are connected to the communication bus BS. The “communication bus BS” has a network structure in which a plurality of controllers (control units) are suspended from a communication line. Signal transmission is performed between a plurality of controllers (EA, EB, ED, and the like) by the communication bus BS. That is, the plurality of controllers can transmit signals (detection values, calculation values, control flags, and the like) to the communication bus BS, and can receive the signals from the communication bus BS.

### Upper Braking Unit SA

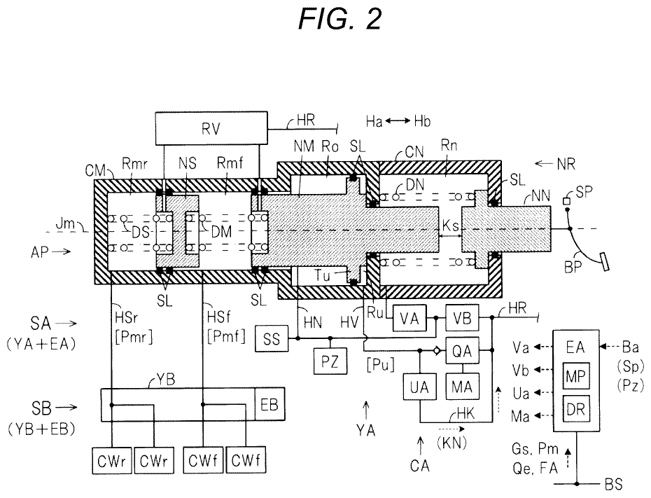

A configuration example of the upper braking unit SA will be described with reference to a schematic diagram of FIG. 2. The upper braking unit SA generates a supply pressure Pm according to an operation of the braking operation member BP (a brake pedal). The supply pressure Pm is finally supplied to the wheel cylinder CW via the communication passage HS (the fluid passage) and the lower braking unit SB. The upper braking unit SA includes the upper actuator YA and the upper controller EA.

### Upper Actuator YA

The upper actuator YA includes an applying unit AP, a pressure adjustment unit CA, and an input unit NR.

### Applying Unit AP

In response to the operation of the braking operation member BP, the supply pressure Pm is output from the applying unit AP. The applying unit AP includes the tandem type master cylinder CM and primary and secondary master pistons NM, NS.

The primary and secondary master pistons NM, NS are inserted into the tandem type master cylinder CM. The inside of the master cylinder CM is divided into four liquid pressure chambers Rmf, Rmr, Ru, and Ro by the two master pistons NM, NS. The front wheel and rear wheel master chambers Rmf, Rmr (=Rm) are divided by one side bottom of the master cylinder CM and the master pistons NM, NS. Furthermore, the inside of the master cylinder CM is partitioned into the servo chamber Ru and the reaction force chamber Ro by a flange portion Tu of the master piston NM. The master chamber Rm and the servo chamber Ru are arranged to face each other with the flange portion Tu sandwiched therebetween. The liquid pressure chambers Rmf, Rmr, Ru, and Ro are sealed by seal members SL. A pressure receiving area rm of the master chamber Rm and a pressure receiving area ru of the servo chamber Ru are made equal.

At the time of non-braking, the master pistons NM, NS are at a most retreating position (that is, a position at which a volume of the master chamber Rm becomes maximum). In this state, the master chamber Rm of the master cylinder CM communicates with a master reservoir RV. The braking liquid BF is stored in the master reservoir RV (also referred to as an atmospheric pressure reservoir) . When the braking operation member BP is operated, the master pistons NM, NS are moved in a forward direction Ha (a direction in which the volume of the master chamber Rm decreases). The communication between the master chamber Rm and the master reservoir RV is blocked by the movement. When the master pistons NM, NS are further moved in the forward direction Ha, front wheel and rear wheel supply pressures Pmf, Pmr (=Pm) are increased from “0 (an atmospheric pressure)”. Accordingly, the braking liquid BF pressurized to the supply pressure Pm is output (pumped) from the master chamber Rm of the master cylinder CM. The supply pressure Pm is a liquid pressure in the master chamber Rm, and thus the supply pressure Pm is also referred to as a “master pressure”.

### Pressure Adjustment Unit CA

A servo pressure Pu is supplied to the servo chamber Ru of the applying unit AP by the pressure adjustment unit CA. The pressure adjustment unit CA includes an upper electric motor MA, the upper fluid pump QA, and a pressure adjustment valve UA.

The upper electric motor MA (also simply referred to as an “electric motor”) drives the upper fluid pump QA (also simply referred to as the “fluid pump”). In the fluid pump QA, the suction portion and the discharge portion are connected by the reflux passage HK (fluid passage). The suction portion of the fluid pump QA is also connected to the master reservoir RV via the reservoir passage HR. A check valve is provided at the discharge portion of the fluid pump QA.

The reflux passage HK is provided with the normally open type pressure adjustment valve UA. The pressure adjustment valve UA is a linear type solenoid valve in which a valve opening amount is continuously controlled based on an energization state (for example, a supply current Ia). The pressure adjustment valve UA adjusts a liquid pressure difference (a differential pressure) between the upstream side and the downstream side, and thus the pressure adjustment valve UA is also referred to as a “differential pressure valve”.

When the electric motor MA is driven and the braking liquid BF is discharged from the fluid pump QA, the circulation flow KN (indicated by a dashed arrow) of the braking liquid BF is generated in the reflux passage HK. When the pressure adjustment valve UA is in a fully open state (at the time of non-energization as the pressure adjustment valve UA is of a normally open type), the liquid pressure Pu (referred to as the “servo pressure”) between the discharge portion of the fluid pump QA and the pressure adjustment valve UA in the reflux passage HK is “0 (the atmospheric pressure) ”. When the energization amount Ia (the supply current) to the pressure adjustment valve UA is increased, the circulation flow KN (the flow of the braking liquid BF circulating in the reflux passage HK) is throttled by the pressure adjustment valve UA. In other words, the flow passage of the reflux passage HK is narrowed by the pressure adjustment valve UA, and an orifice effect due to the pressure adjustment valve UA is exhibited. Accordingly, the liquid pressure Pu on the upstream side of the pressure adjustment valve UA is increased from “0”. That is, in the circulation flow KN, the liquid pressure difference (the differential pressure) is generated between the liquid pressure Pu (the servo pressure) on the upstream side and the liquid pressure (the atmospheric pressure) on the downstream side with respect to the pressure adjustment valve UA. The differential pressure is adjusted by the supply current Ia to the pressure adjustment valve UA.

The reflux passage HK is connected to the servo chamber Ru via the servo passage HV (the fluid passage) at a portion between the discharge portion of the fluid pump QA (specifically, a downstream portion of the check valve) and the pressure adjustment valve UA. Therefore, the servo pressure Pu is introduced (supplied) to the servo chamber Ru. The increase in the servo pressure Pu presses the master pistons NM, NS in the forward direction Ha, and the liquid pressures Pmf, Pmr (the front wheel and rear wheel supply pressures) in the front wheel and rear wheel master chambers Rmf, Rmr are increased.

The front wheel and rear wheel master chambers Rmf, Rmr (=Rm) are connected to front wheel and rear wheel communication passages HSf, HSr (=HS). The front wheel and rear wheel communication passages HSf, HSr are connected to the front wheel and rear wheel cylinders CWf, CWr (=CW) via the lower braking unit SB (in particular, the lower actuator YB). Therefore, the front wheel and rear wheel supply pressures Pmf, Pmr are supplied from the upper braking unit SA to the front wheel and rear wheel cylinders CWf, CWr. Here, the front wheel supply pressure Pmf and the rear wheel supply pressure Pmr are equal (that is, “Pmf=Pmr”).

### Input Unit NR

The braking operation member BP is operated by the input unit NR so as to achieve a regenerative coordination control, but a state where the wheel pressure Pw is not generated is formed. The “regenerative coordination control” causes the friction braking force Fm (a braking force generated by the wheel pressure Pw) and a regenerative braking force Fg (a braking force generated by a motor/generator (not shown) ) to work together such that kinetic energy of the vehicle JV can be efficiently recovered into electric energy by the motor/generator during the braking. The input unit NR includes an input cylinder CN, an input piston NN, an introduction valve VA, a release valve VB, the stroke simulator SS, and the simulator pressure sensor PZ.

The input cylinder CN is fixed to the master cylinder CM. The input piston NN is inserted into the input cylinder CN. The input piston NN is mechanically connected to the braking operation member BP via a clevis (U-shaped link) so as to be interlocked with the braking operation member BP (brake pedal). An end surface of the input piston NN and an end surface of the primary master piston NM have a gap Ks (also referred to as a “separation displacement”). By adjusting the gap Ks by the servo pressure Pu, the regenerative coordination control is achieved.

An input chamber Rn of the input unit NR is connected to the reaction force chamber Ro of the applying unit AP via the input passage HN (the fluid passage). The normally closed type introduction valve VA is provided in the input passage HN. The input passage HN is connected to the master reservoir RV via the reservoir passage HR between the introduction valve VA and the reaction force chamber Ro. The reservoir passage HR is provided with the normally open type release valve VB. The introduction valve VA and the release valve VB are on-off type solenoid valves. The stroke simulator SS (also simply referred to as the “simulator”) is connected to the input passage HN between the introduction valve VA and the reaction force chamber Ro.

When the power supply to the introduction valve VA and the release valve VB is not performed, the introduction valve VA is closed and the release valve VB is opened. The input chamber Rn is sealed by closing the introduction valve VA, and the fluid is locked. Accordingly, the master pistons NM, NS are displaced integrally with the braking operation member BP. The simulator SS communicates with the master reservoir RV by opening the release valve VB. When power supply to the introduction valve VA and the release valve VB is performed, the introduction valve VA is opened, and the release valve VB is closed. Accordingly, the master pistons NM, NS can be separately displaced from the braking operation member BP. In this case, since the input chamber Rn is connected to the stroke simulator SS, an operation force Fp of the braking operation member BP is generated by the simulator SS. The simulator pressure sensor PZ is provided in the input passage HN between the introduction valve VA and the reaction force chamber Ro so as to detect the liquid pressure Pz (the simulator pressure) in the simulator SS. Note that since the simulator pressure Pz is also an internal pressure of the input chamber Rn, the simulator pressure Pz is also a state quantity representing the operation force Fp of the braking operation member BP.

A state where the master pistons NM, NS and the braking operation member BP are separately displaced from each other (at the time of energization of the solenoid valves VA and VB) is referred to as a “first mode (or a by-wire mode)”. In the first mode, the braking control device SC functions as a brake-by-wire type device (that is, a device capable of generating the friction braking force Fm independently with respect to a braking operation of the driver). Therefore, in the first mode, the wheel pressure Pw is generated independently of the operation of the braking operation member BP. On the other hand, a state where the master pistons NM, NS and the braking operation member BP are integrally displaced (at the time of non-energization of the solenoid valves VA and VB) is referred to as a “second mode (or a manual mode)”. In the second mode, the wheel pressure Pw is linked to the braking operation of the driver. In the input unit NR, one operation mode of the first mode (the by-wire mode) and the second mode (the manual mode) is selected based on the presence or absence of the power supply to the introduction valve VA and the release valve VB.

### Upper Controller EA

The upper actuator YA is controlled by the upper controller EA. The upper controller EA includes a microprocessor MP and a drive circuit DR. The upper controller EA is connected to the communication bus BS such that signals (detection values, calculation values, control flags, and the like) can be shared with other controllers (EB, ED, and the like).

The braking operation amount Ba is input to the upper controller EA. The braking operation amount Ba is a generic term for a state quantity representing the operation amount of the braking operation member BP. The detection signal Sp (the operation displacement) of the operation displacement sensor SP and the detection signal Pz (the simulator pressure) of the simulator pressure sensor PZ are directly input to the upper controller EA from the braking operation amount sensor BA as the braking operation amount Ba. The supply pressure Pm, the required deceleration Gs, or the like is input to the upper controller EA via the communication bus BS. The “supply pressure Pm” is an output pressure of the upper actuator YA. The supply pressure Pm is detected by a supply pressure sensor PM provided in the lower actuator YB and transmitted from the lower controller EB. The required deceleration Gs is a required value for the automatic braking control, is calculated by the driving assistance controller ED, and is transmitted from the driving assistance controller ED.

An algorithm for the pressure adjustment control is programmed in the upper controller EA (in particular, the microprocessor MP). The “pressure adjustment control” is a control for adjusting the supply pressure Pm (finally, the wheel pressure Pw). The pressure adjustment control is executed based on the braking operation amount Ba (the operation displacement Sp, the simulator pressure Pz), the required deceleration Gs, the supply pressure Pm, and the like. Here, the braking operation amount Ba and the required deceleration Gs are generically referred to as a “required braking amount Bs”. The required braking amount Bs is an input signal for instructing (requiring) generation of the supply pressure Pm (result, the wheel pressure Pw to be generated by the braking control device SC).

Based on the algorithm of the pressure adjustment control, the electric motor MA and various solenoid valves (UA and the like) constituting the upper actuator YA are driven by the drive circuit DR. In the drive circuit DR, an H-bridge circuit is implemented by a switching element (for example, a MOS-FET) to drive the electric motor MA. The drive circuit DR includes a switching element to drive the various solenoid valves (UA and the like). In addition, the drive circuit DR includes a motor current sensor (not shown) that detects a supply current Im (referred to as a “motor current”) to the electric motor MA, and a pressure adjustment valve current sensor (not shown) that detects the supply current Ia (referred to as a “pressure adjustment valve current”) to the pressure adjustment valve UA. The electric motor MA is provided with a rotation angle sensor (not shown) that detects a rotation angle Ka (referred to as a “motor rotation angle”) of a rotary element (a rotor) of the electric motor MA. Then, a motor rotation number Na is calculated based on the motor rotation angle Ka.

In the upper controller EA, a target current It (a target value) corresponding to the pressure adjustment valve current Ia (an actual value) is calculated based on the required braking amount Bs (Ba, Gs, and the like) for a vehicle. In the control of the pressure adjustment valve UA, the pressure adjustment valve current Ia is controlled to be close to and coincide with the target current It. In the upper controller EA, a target rotation number Nt (a target value) corresponding to the motor rotation number Na (an actual value) is calculated based on the required braking amount Bs. In the control of the electric motor MA, the motor current Im is controlled such that the actual rotation number Na is close to and coincides with the target rotation number Nt. Specifically, if “Nt>Na”, the motor current Im is increased such that the actual rotation number Na increases, and if “Nt<Na”, the motor current Im is decreased such that the actual rotation number Na decreases. Based on these control algorithms, a drive signal Ma for controlling the electric motor MA and drive signals Ua, Va, Vb for controlling the various solenoid valves UA, VA, VB are calculated. Then, according to the drive signals (Ma and the like), switching elements of the drive circuit DR are driven, and the electric motor MA and the solenoid valves UA, VA, VB are controlled.

### Lower Braking Unit SB

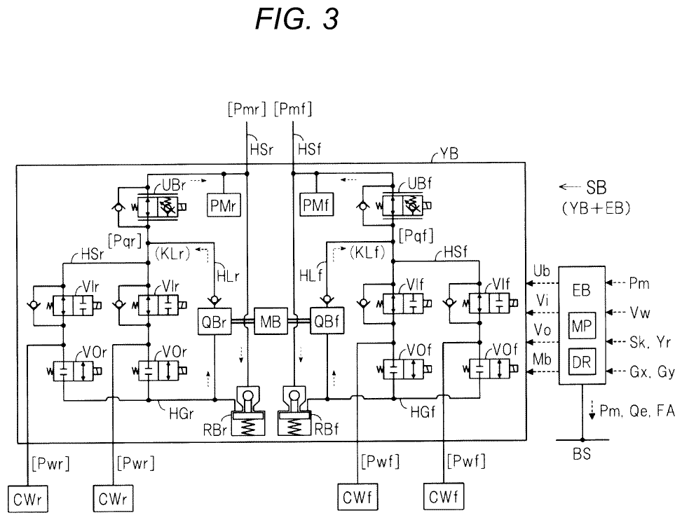

A configuration example of the lower braking unit SB of the braking control device SC will be described with reference to a schematic diagram of FIG. 3. The lower braking unit SB is a general-purpose unit (device) for executing an antilock brake control, a traction control, an electronic stability control, and the like.

The front wheel and rear wheel supply pressures Pmf, Pmr (=Pm) are supplied from the upper braking unit SA to the lower braking unit SB. Then, in the lower braking unit SB, the front wheel and rear wheel supply pressures Pmf, Pmr are adjusted (increased or decreased), and are finally output as liquid pressures Pwf, Pwr (front wheel and rear wheel pressures) of the front wheel and rear wheel cylinders CWf, CWr. The lower braking unit SB includes the lower actuator YB and the lower controller EB.

### Lower Actuator YB

The lower actuator YB is provided between the upper actuator YA and the wheel cylinder CW in the communication passage HS. The lower actuator YB includes the supply pressure sensor PM, a control valve UB, the lower fluid pump QB, a lower electric motor MB, a pressure adjustment reservoir RB, an inlet valve VI, and an outlet valve VO.

Front wheel and rear wheel control valves UBf, UBr (=UB) are provided in the front wheel and rear wheel communication passages HSf, HSr (=HS). The control valve UB is a normally open type linear solenoid valve (differential pressure valve) similar to the pressure adjustment valve UA. The wheel pressure Pw can be increased from the supply pressure Pm by the control valve UB individually for front wheel and rear wheel systems.

Front wheel and rear wheel supply pressure sensors PMf, PMr (=PM) are provided to detect the actual liquid pressures Pmf, Pmr (the front wheel and rear wheel supply pressures) supplied from the upper actuator YA (in particular, the front wheel and rear wheel master chambers Rmf, Rmr). The supply pressure sensor PM is also referred to as a “master pressure sensor”, and is built in the lower actuator YB. Signals of the front wheel and rear wheel supply pressures Pmf, Pmr (=Pm) are directly input to the lower controller EB and are output to the communication bus BS. Since the front wheel supply pressure Pmf and the rear wheel supply pressure Pmr are substantially the same, either one of the front wheel and rear wheel supply pressure sensors PMf, PMr may be omitted. For example, in a configuration in which the rear wheel supply pressure sensor PMr is omitted, only the front wheel supply pressure Pmf is detected by the front wheel supply pressure sensor PMf.

Front wheel and rear wheel return passages HLf, HLr (=HL) connect upper portions of the front wheel and rear wheel control valves UBf, UBr (portions of the communication passages HS closer to the upper actuator YA) to lower portions of the front wheel and rear wheel control valves UBf, UBr (portions of the communication passages HS closer to the wheel cylinders CW). The front wheel and rear wheel return passages HLf, HLr are provided with front wheel and rear wheel lower fluid pumps QBf, QBr (=QB) and front wheel and rear wheel pressure adjustment reservoirs RBf, RBr (=RB). The lower fluid pump QB is driven by the lower electric motor MB.

When the lower electric motor MB (also simply referred to as the “electric motor”) is driven, the braking liquid BF is suctioned from the upper portion of the control valve UB and is discharged to the lower portion of the control valve UB by the lower fluid pump QB (also simply referred to as the “fluid pump”). Accordingly, the circulation flow KL (that is, front wheel and rear wheel circulation flows KLf, KLr as indicated by dashed arrows) of the braking liquid BF, including the fluid pump QB, the control valve UB, and the pressure adjustment reservoir RB, is generated in the communication passage HS and the return passage HL. When the flow passage of the communication passage HS is narrowed by the control valve UB and the circulation flow KL of the braking liquid BF is throttled, the orifice effect in this case increases a liquid pressure Pq (referred to as an “adjustment pressure”) at the lower portion of the control valve UB from the liquid pressure Pm (the supply pressure) at the upper portion of the control valve UB. In other words, in the circulation flow KL, with respect to the control valve UB, the liquid pressure difference (differential pressure) between the liquid pressure Pm (the supply pressure) on the downstream side and the liquid pressure Pq (the adjustment pressure) on the upstream side is adjusted by the control valve UB. In terms of a magnitude relationship between the supply pressure Pm and the adjustment pressure Pq, the adjustment pressure Pq is equal to or higher than the supply pressure Pm (that is, “Pq>Pm”). As described above, a generation mechanism of the adjustment pressure Pq in the lower actuator YB is the same as a generation mechanism of the servo pressure Pu in the upper actuator YA.

Inside the lower actuator YB, the front wheel and rear wheel communication passages HSf, HSr are respectively branched into two and connected to the front wheel and rear wheel cylinders CWf, CWr. The normally open type inlet valve VI and the normally closed type outlet valve VO are provided for each wheel cylinder CW such that each wheel pressure Pw can be adjusted individually. Specifically, the inlet valve VI is provided in the branched communication passage HS (that is, on the side closer to the wheel cylinder CW with respect to the branching portion of the communication passage HS). The communication passage HS is connected to the pressure adjustment reservoir RB via the depressurization passage HG (the fluid passage) at the lower portion of the inlet valve VI (the portion of the communication passage HS closer to the wheel cylinder CW). The outlet valve VO is disposed in the depressurization passage HG. On-off type solenoid valves are adopted as the inlet valve VI and the outlet valve VO. The wheel pressure Pw can be decreased from the adjustment pressure Pq (or the supply pressure Pm) individually at each wheel by the inlet valve VI and the outlet valve VO. Accordingly, the antilock brake control, the traction control, the electronic stability control, and the like are executed.

### Lower Controller EB

The lower actuator YB is controlled by the lower controller EB. The lower controller EB, similar to the upper controller EA, includes the microprocessor MP and the drive circuit DR. The lower controller EB is connected to the communication bus BS, and thus the upper controller EA and the lower controller EB can share signals via the communication bus BS.

The wheel speed Vw, the steering operation amount Sk, the yaw rate Yr, the longitudinal acceleration Gx, and the lateral acceleration Gy are input to the lower controller EB (in particular, the microprocessor MP). The lower controller EB executes the antilock brake control, the traction control, the electronic stability control, and the like. Specifically, the lower controller EB drives the lower electric motor MB and various solenoid valves (UB and the like) constituting the lower actuator YB to execute these controls. In the drive circuit DR of the lower controller EB, an H-bridge circuit is implemented by a switching element (for example, a MOS-FET) to drive the lower electric motor MB. The drive circuit DR includes a switching element to drive the various solenoid valves (UB and the like). Based on a control algorithm programmed in the microprocessor MP, a drive signal Ub of the control valve UB, a drive signal Vi of the inlet valve VI, a drive signal Vo of the outlet valve VO, and a drive signal Mb of the lower electric motor MB are calculated. Based on the drive signals (Ub and the like), the drive circuit DR controls the lower electric motor MB and the solenoid valves UB, VI, VO.

The lower controller EB calculates the vehicle body speed Vx based on the wheel speed Vw. When the antilock brake control (also referred to as an “ABS control”) is executed, a deceleration slip (a difference between the vehicle body speed Vx and the wheel speed Vw) that indicates a degree of a slip state of each wheel WH is calculated based on the vehicle body speed Vx and the wheel speed Vw. When the deceleration slip exceeds a control threshold (a predetermined value set in advance), the wheel pressure Pw is adjusted so that the wheels do not lock. That is, the lower controller EB controls the inlet valve VI and the outlet valve VO to decrease, increase, and maintain the wheel pressure Pw for each wheel cylinder CW individually.

When the inlet valve VI and the outlet valve VO are not supplied with power and operations thereof are stopped, the inlet valve VI is opened and the outlet valve VO is closed. In this state, the wheel pressure Pw is equal to the adjustment pressure Pq. When the ABS control is executed, the wheel pressure Pw is independently adjusted for each wheel cylinder CW by driving the inlet valve VI and the outlet valve VO. In order to decrease the wheel pressure Pw, the inlet valve VI is closed and the outlet valve VO is opened. An inflow of the braking liquid BF into the wheel cylinder CW is prevented, and the braking liquid BF in the wheel cylinder CW flows out to the pressure adjustment reservoir RB, and thus the wheel pressure Pw is decreased. In order to increase the wheel pressure Pw, the inlet valve VI is opened and the outlet valve VO is closed. The braking liquid BF is prevented from flowing out to the pressure adjustment reservoir RB, and the adjustment pressure Pq from the pressure adjustment valve UB is supplied to the wheel cylinder CW, and thus the wheel pressure Pw is increased. Here, an upper limit of the increase in the wheel pressure Pw is the adjustment pressure Pq. In order to maintain the wheel pressure Pw, both the inlet valve VI and the outlet valve VO are closed. Since the wheel cylinder CW is fluidically sealed, the wheel pressure Pw is maintained constant.

In the lower braking unit SB, the wheel pressure Pw in the ABS control is decreased by moving the braking liquid BF from the wheel cylinder CW to the pressure adjustment reservoir RB. Since a volume of the pressure adjustment reservoir RB is finite, when the ABS control is executed, the electric motor MB is driven to prevent the volume from becoming full. When the electric motor MB is driven, the braking liquid BF flowing into the pressure adjustment reservoir RB is pumped out of the pressure adjustment reservoir RB by the fluid pump QB and returned to an upper portion of the inlet valve VI. Accordingly, the wheel pressure Pw can be continuously decreased.

### Drive Control of Pressure Adjustment Valve UA

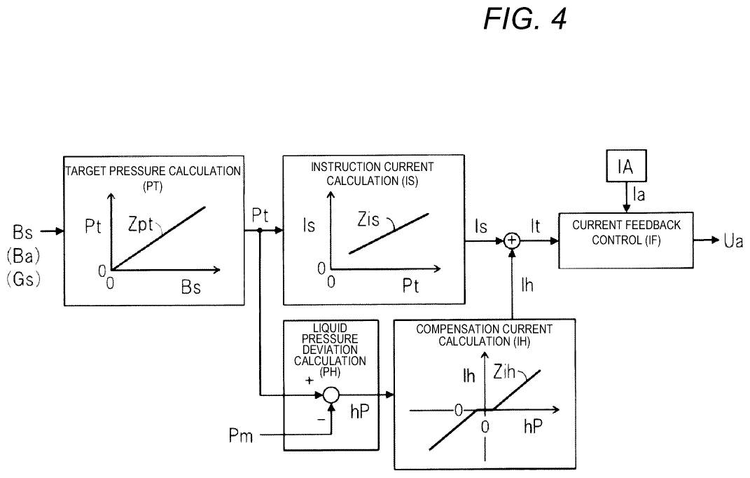

A processing example of a drive control of the pressure adjustment valve UA will be described with reference to a block diagram of FIG. 4. The processing is executed by the upper controller EA. The pressure adjustment valve UA adjusts the servo pressure Pu, and finally adjusts the supply pressure Pm (=PW). The drive control of the pressure adjustment valve UA is implemented by a target pressure calculation block PT, an instruction current calculation block IS, a liquid pressure deviation calculation block PH, a compensation current calculation block IH, and a current feedback control block IF.

In the target pressure calculation block PT, a target pressure Pt is calculated based on the required braking amount Bs. The “required braking amount Bs” is a generic term of the braking operation amount Ba and the required deceleration Gs, and is an input for instructing the generation of the supply pressure Pm (that is, the wheel pressure Pw to be generated by the braking control device SC). The required braking amount Bs is calculated based on the braking operation amount Ba and the required deceleration Gs. For example, the braking operation amount Ba and the required deceleration Gs are compared in the dimension of the vehicle deceleration, and the larger one is determined as the required braking amount Bs. The “target pressure Pt” is a target value corresponding to the supply pressure Pm. The target pressure Pt is calculated according to a calculation map Zpt set in advance so as to increase as the required braking amount Bs increases. That is, the target pressure Pt is determined to be greater as the required braking amount Bs increases.

In the instruction current calculation block IS, an instruction current Is is calculated based on the target pressure Pt and a calculation map Zis set in advance. The “instruction current Is” is a target value corresponding to the supply current Ia of the pressure adjustment valve UA required to achieve the target pressure Pt. According to the calculation map Zis, the instruction current Is is determined to increase as the target pressure Pt increases. The instruction current calculation block IS corresponds to a feedforward control based on the target pressure Pt.

In the liquid pressure deviation calculation block PH, a deviation hP (referred to as a “liquid pressure deviation”) between the target pressure Pt and the supply pressure Pm is calculated. Specifically, the supply pressure Pm is subtracted from the target pressure Pt to determine the liquid pressure deviation hp (that is, “hP=Pt−Pm”).

In the compensation current calculation block IH, a compensation current Ih is calculated based on the liquid pressure deviation hP and a calculation map Zih set in advance. The instruction current Is is calculated corresponding to the target pressure Pt, but an error may occur between the target pressure Pt and the supply pressure Pm. The “compensation current Ih” is used to compensate (decrease) this error. The compensation current Ih is determined to increase as the liquid pressure deviation hP increases according to the calculation map Zih. Specifically, if the target pressure Pt is greater than the supply pressure Pm and the liquid pressure deviation hP has a positive sign, the compensation current Ih with a positive sign is determined such that the instruction current Is is increased. On the other hand, if the target pressure Pt is less than the supply pressure Pm and the liquid pressure deviation hP has a negative sign, the compensation current Ih with the negative sign is determined such that the instruction current Is is decreased. Here, a dead zone is provided in the calculation map Zih. The compensation current calculation block IH corresponds to a feedback control based on the supply pressure Pm.

The compensation current Ih is added to the instruction current Is to calculate the target current It (that is, “It=Is+Ih”). The “target current It” is a final target value of the current supplied to the pressure adjustment valve UA. That is, the target current It is determined as the sum of the instruction current Is, which is a feedforward term, and the compensation current Ih, which is a feedback term. Therefore, the drive control of the pressure adjustment valve UA includes the feedforward control (processing of the instruction current calculation block IS) and the feedback control (processing of the compensation current calculation block IH) in terms of the liquid pressure.

In the current feedback control block IF, the drive signal Ua is calculated based on the target current It (the target value) and the supply current Ia (the actual value) such that the supply current Ia is close to and coincides with the target current It. Here, the supply current Ia is detected by a pressure adjustment valve current sensor IA provided in the drive circuit DR. In the current feedback control block IF, if “It>Ia”, the drive signal Ua is determined such that the supply current Ia increases. On the other hand, if “It<Ia”, the drive signal Ua is determined such that the supply current Ia decreases. That is, in the current feedback control block IF, the feedback control related to the current is executed. Therefore, the drive control of the pressure adjustment valve UA includes the feedback control related to the current in addition to the feedback control related to the liquid pressure.

### Drive Control of Electric Motor MA

Before describing a control example of the electric motor MA, a flow rate of the braking liquid BF required at the time of executing the antilock brake control (the ABS control) is described. In the ABS control, in the wheel cylinder CW corresponding to the wheel WH in which a tendency of wheel lock (that is, an increase in the deceleration slip) is shown, the depressurization is performed to prevent this tendency. The wheel pressure Pw is decreased by moving the braking liquid BF from the wheel cylinder CW to the pressure adjustment reservoir RB through the outlet valve VO. When the deceleration slip (the difference between the vehicle body speed Vx and the wheel speed Vw) is decreasing, the wheel cylinder CW is pressurized to restore the decreased braking force. The wheel pressure Pw is increased by moving the braking liquid BF from the upper portion of the inlet valve VI to the wheel cylinder CW. In this case, the braking liquid BF is supplied to the wheel cylinder CW by being returned from the pressure adjustment reservoir RB to the upper portion of the inlet valve VI by the lower fluid pump QB driven by the lower electric motor MB. In addition, the braking liquid BF is also supplied to the wheel cylinder CW from the upper braking unit SA. Therefore, if an amount of the braking liquid BF supplied from the upper braking unit SA (for example, a liquid amount per unit time) is insufficient, the amount of braking liquid may be insufficient when the ABS control is executed by the lower braking unit SB. When the liquid amount is insufficient, a situation may occur in which an increase rate of the wheel pressure Pw (an increase amount of the wheel pressure Pw per unit time, also referred to as an “increase gradient”) is not sufficiently obtained.

### First Control Example Related to Motor Rotation Number Na

In the braking control device SC, when the ABS control is not executed, the upper electric motor MA is driven at a constant rotation number na (a constant) set in advance. In order to avoid the above-described shortage of liquid amount, when the lower braking unit SB executes the ABS control, the upper braking unit SA increases the rotation number Na (the motor rotation number) of the electric motor MA. Here, an increase amount Nz the motor rotation number Na is set to a predetermined rotation number nx (a constant) in advance so as to correspond to a liquid amount required for the ABS control.

In a first control example, the upper electric motor MA is driven at the constant rotation number na before the ABS control starts, and is increased by the predetermined rotation number nx from the constant rotation number na at a time point (a corresponding calculation period) of the start of the ABS control. For example, information that “the ABS control is executed” is transmitted by transmitting an execution flag FA from the lower braking unit SB to the upper braking unit SA via the communication bus BS. The “execution flag FA” is a control flag that indicates whether the ABS control is being executed by the lower braking unit SB. In the execution flag FA, “0” indicates that the ABS control is not executed, and “1” indicates that the ABS control is being executed. In the upper braking unit SA, at a time point of switching the execution flag FA from “0” to “1” (the time point of the start of the ABS control), the predetermined rotation number nx is added to the target rotation number Nt of the electric motor MA. An increase in the actual motor rotation number Na is performed by the target rotation number Nt increased by the predetermined rotation number nx. That is, as a control result of “Nt=na+nx”, “Na=na+nx” is achieved.

In the braking control device SC, when the ABS control is executed by the lower braking unit, the rotation number Na of the electric motor MA is increased, so that the liquid amount of the braking liquid BF (the flow rate which is the liquid amount per unit time) supplied from the upper braking unit SA to the lower braking unit SB is increased. Accordingly, in the lower braking unit SB, a sufficient liquid amount is secured for executing the ABS control. As a result, the increase gradient of the wheel pressure Pw is sufficiently ensured in the ABS control, and performance of the ABS control is improved.

### Second Control Example Related to Motor Rotation Number Na

In the ABS control, the wheel pressure Pw is adjusted individually for each wheel cylinder CW, and thus the amount of the braking liquid BF required for the lower braking unit SB depends on a control mode of each wheel cylinder CW. Here, the “control mode” includes a pressurization mode in which the wheel pressure Pw is increased, a holding mode in which the wheel pressure Pw is maintained constant, and a depressurization mode in which the wheel pressure Pw is decreased. In the pressurization mode, movement of the braking liquid BF to the wheel cylinder CW is necessary. However, in the holding mode or the depressurization mode, the inlet valve VI is closed, and the movement of the braking liquid BF to the wheel cylinder CW is unnecessary. That is, in the ABS control, the amount of the braking liquid required in the lower braking unit SB changes from moment to moment. Note that the holding mode may be omitted in the control mode. In the ABS control in the configuration, either the pressurization mode or the depressurization mode is selected.

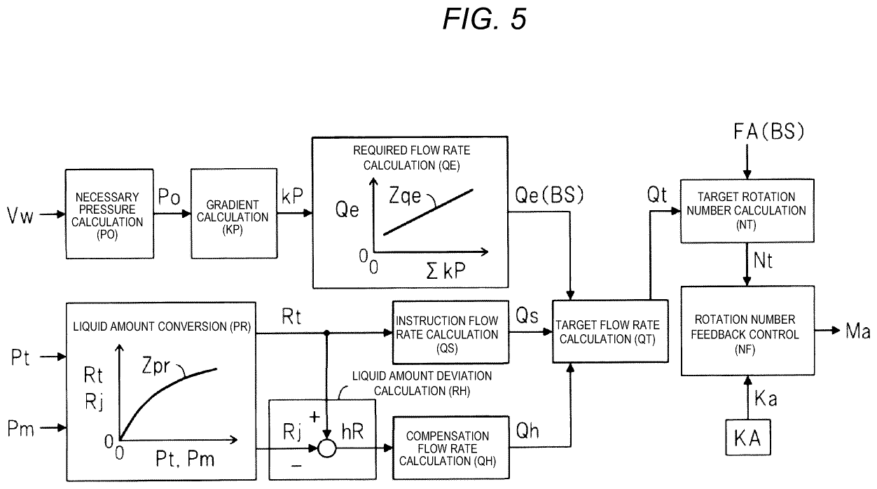

A second control example of the upper electric motor MA corresponding to the above-described flow rate change will be described with reference to a block diagram of FIG. 5. The second control example of the electric motor MA is implemented by a necessary pressure calculation block PO, a gradient calculation block KP, a required flow rate calculation block QE, a liquid amount conversion block PR, a liquid amount deviation calculation block RH, an instruction flow rate calculation block QS, a compensation flow rate calculation block QH, a target flow rate calculation block QT, a target rotation number calculation block NT, and a rotation number feedback control block NF. For example, processing of the necessary pressure calculation block PO, the gradient calculation block KP, and the required flow rate calculation block QE is executed by the lower controller EB, and another processing (PR, RH, or the like) is executed by the upper controller EA.

In the necessary pressure calculation block PO, a necessary pressure Po corresponding to the wheel pressure PW of each wheel cylinder CW is calculated based on the wheel speed Vw. The “necessary pressure Po” is a target value for each wheel cylinder CW required for executing the ABS control (the antilock brake control). The wheel pressure Pw is adjusted based on the necessary pressure Po, thereby individually avoiding locking of each wheel WH.

In the necessary pressure calculation block PO, first, the vehicle body speed Vx is calculated based on the wheel speed Vw. Then, in the ABS control, a slip state of the wheel WH is calculated based on a comparison result between the vehicle body speed Vx and the wheel speed Vw of each wheel WH. For example, as the slip state, the deceleration slip, which is the difference between the wheel speed Vw of each wheel WH and the vehicle body speed Vx, is determined. The necessary pressure Po is determined for each wheel so that the lock of each wheel WH is prevented.

In the gradient calculation block KP, an increase gradient kP (also referred to as a “target increase gradient”) is calculated based on the necessary pressure Po. Specifically, the necessary pressure Po in each wheel cylinder CW is time-differentiated, and respective increase gradients (the increase amount of the necessary pressure Po per unit time) are determined as the increase gradients kP. Therefore, the “increase gradient kP” is a target value corresponding to the increase gradient (the increase amount per unit time) of the actual wheel pressure Pw. Note that when the necessary pressure Po is maintained at a constant value, or when the necessary pressure Po is decreased, the increase gradient kP is determined to be “0”.

In the required flow rate calculation block QE, a required flow rate Qe is calculated based on the increase gradient kP (the target increase gradient) corresponding to each wheel cylinder CW. The “required flow rate Qe” is the flow rate of the braking liquid BF required to execute the ABS control. The required flow rate Qe is determined based on a sum EkP (a total value) of the increase gradients kP of the respective wheel cylinders CW. Specifically, in the required flow rate calculation block QE, the increase gradients kP are added to calculate the total value EkP. According to a calculation map Zqe set in advance, the required flow rate Qe is determined to be greater as the total value EkP increases. The required flow rate Qe is transmitted from the lower controller EB to the communication bus BS and received by the upper controller EA.

In the liquid amount conversion block PR, a target liquid amount Rt and an actual liquid amount Rj are calculated based on the target pressure Pt and the supply pressure Pm. In the liquid amount conversion block PR, the target pressure Pt is converted to the target liquid amount Rt, and the supply pressure Pm is converted to the actual liquid amount Rj based on a calculation map Zpr set in advance. Here, the “target liquid amount Rt” is a liquid amount required to achieve the target pressure Pt (a volume of the braking liquid BF to be moved to the wheel cylinder CW). The “actual liquid amount Rj” is a liquid amount that has already flowed into the wheel cylinder CW to generate the supply pressure Pm (result, the wheel pressure Pw).

In the liquid amount deviation calculation block RH, a deviation hR (referred to as a “liquid amount deviation”) between the target liquid amount Rt and the actual liquid amount Rj is calculated. Specifically, the actual liquid amount Rj is subtracted from the target liquid amount Rt to determine the liquid amount deviation hR (that is, “hR=Rt−Rj”). The “liquid amount deviation hR” is a target value of the liquid amount (a volume) to flow into the wheel cylinder CW in the future to achieve the target pressure Pt.

In the instruction flow rate calculation block QS, an instruction flow rate Qs is calculated based on the target liquid amount Rt. Specifically, the target liquid amount Rt is time-differentiated to determine the instruction flow rate Qs (that is, “Qs=d(Rt)/dt”). The instruction flow rate calculation block QS corresponds to the feedforward control in the flow rate control.

In the compensation flow rate calculation block QH, a compensation flow rate Qh is calculated based on the liquid amount deviation hR. Specifically, the liquid amount deviation hR is time-differentiated to determine the compensation flow rate Qh (that is, “Qh=d (hR)/dt”). The compensation flow rate calculation block QH corresponds to the feedback control in the flow rate control.

In the target flow rate calculation block QT, a target flow rate Qt is calculated based on the required flow rate Qe, the instruction flow rate Qs, and the compensation flow rate Qh. The “target flow rate Qt” is a final target value that is estimated to be a flow rate necessary to achieve the target pressure Pt and execute the ABS control in the lower braking unit SB. Specifically, the required flow rate Qe, the instruction flow rate Qs, and the compensation flow rate Qh are added together to determine the target flow rate Qt (that is, “Qt=Q +Qs+Qh”). That is, when the ABS control is executed by the lower braking unit SB, the target flow rate Qt is determined to be larger by the required flow rate Qe compared to that when the ABS control is not executed. Note that when the ABS control is not executed by the lower braking unit SB, “Qe=0” is satisfied, and thus the target flow rate Qt is calculated as a sum of the instruction flow rate Qs and the compensation flow rate Qh.

In the target rotation number calculation block NT, the target rotation number Nt is calculated based on the target flow rate Qt. The “target rotation number Nt” is a target value corresponding to the rotation number Na (the actual value) of the electric motor MA. Specifically, the target rotation number Nt is determined based on a discharge amount (a volume of the braking liquid BF discharged per rotation) of the fluid pump QA so that the target rotation number Nt is greater as the target flow rate Qt increases. In the target rotation number Nt, a minimum flow rate of the pressure adjustment valve UA and a minimum rotation number of the electric motor MA are taken into consideration. The “minimum flow rate” is a lowest limit flow rate required for the pressure adjustment valve UA to adjust the servo pressure Pu, and is set in advance. The “minimum rotation number” is a minimum value of the rotation number at which the electric motor MA can continue to rotate stably. Taking these matters into consideration, a lower limit rotation number nt (a predetermined value set in advance) is set for the target rotation number Nt. Therefore, if the target rotation number Nt calculated based on the target flow rate Qt is equal to or higher than the lower limit rotation number nt, no restriction is made by the lower limit rotation number nt, and the calculated target rotation number Nt is used as it is. On the other hand, if the target rotation number Nt calculated based on the target flow rate Qt is less than the lower limit rotation number nt, the target rotation number Nt is determined to be the lower limit rotation number nt (that is, “Nt=nt”).

In the rotation number feedback control block NF, the drive signal Ma is calculated based on the target rotation number Nt (the target value) and the motor rotation number Na (the actual value) so that the motor rotation number Na is close to and coincides with the target rotation number Nt. Here, the motor rotation number Na is calculated based on the detection value Ka (the rotation angle) of a rotation angle sensor KA provided on the electric motor MA. Specifically, the motor rotation angle Ka is time-differentiated to determine the motor rotation number Na. In the rotation number feedback control block NF, if “Nt>Na”, the drive signal Ma is determined such that the actual rotation number Na increases. On the other hand, if “Nt<Na”, the drive signal Ma is determined such that the actual rotation number Na decreases. That is, in the rotation number feedback control block NF, a feedback control related to the motor rotation number is executed.

The second control example of the motor rotation number Na will be summarized. In the braking control device SC, the flow rate (the liquid amount per unit time) of the braking liquid BF required for the ABS control (the antilock brake control) is calculated as the required flow rate Qe. The rotation number Na of the electric motor MA is controlled based on the required flow rate Qe. The second control example of the motor rotation number Na based on the required flow rate Qe is executed as follows.
(1) The necessary pressure Po, which is the target value of the wheel pressure Pw in the ABS control, is calculated for each wheel cylinder CW.
(2) The necessary pressure Po for each wheel cylinder CW is time-differentiated to calculate the target increase gradient kP for each wheel cylinder CW. The increase gradient kP is the increase amount of the necessary pressure Po per unit time in a case (that is, the pressurization mode) where the wheel pressure Pw is increased. Therefore, when the necessary pressure Po is maintained constant (that is, the holding mode) and when the necessary pressure Po is decreased (that is, the depressurization mode), the increase gradient kP is determined to be “0”.
(3) The increase gradients kP of the respective wheel cylinders CW are all added up. The required flow rate Qe is calculated based on the total value EkP (sum) of the increase gradients kP. Specifically, the required flow rate Qe is determined to be greater as the total value EkP increases. That is, the required flow rate Qe is a necessary and lowest limit flow rate in the execution of the ABS control.
(4) Based on the required flow rate Qe, the motor rotation number Na is controlled to be greater as the required flow rate Qe increases. That is, the increase amount Nz of the motor rotation number Na is determined based on the increase gradient kP, and the motor rotation number Na is increased. Note that the required flow rate Qe is set to “0” when the ABS control is not performed, and is calculated at the time point of the start of the ABS control. Therefore, the motor rotation number Na starts to increase at the time point of the start of the ABS control (for example, the time point of switching the execution flag FA input to the target rotation number calculation block NT from “0” to “1”).

As described above, in the upper braking unit SA, the increase amount Nz of the rotation number Na of the electric motor MA is determined based on the target increase gradient kP for the wheel pressure Pw in the ABS control. When the ABS control is executed, the increase amount Nz of the motor rotation number Na may be determined to be the predetermined rotation number nx, as in the first control example. However, the predetermined rotation number nx is expected to have a certain margin. Therefore, by determining the increase amount Nz based on the required flow rate Qe (that is, the increase gradient kP), the motor rotation number Na is increased by an amount necessary for the ABS control. Since the increase in the motor rotation number Na is necessary and minimal, the power consumption of the upper electric motor MA is suppressed. That is, in the second control example, in the upper braking unit SA, the flow rate of the braking liquid BF is increased by the amount necessary for the execution of the ABS control in the lower braking unit SB. Accordingly, the increase gradient (the actual value) of the wheel pressure Pw is secured, the performance of the ABS control is improved, and power saving of the electric motor MA is achieved.

### Other Embodiments

Other embodiments will be described below. The same effects as those described above (such as improvement of performance of the ABS control) can be achieved in other embodiments.

In the above embodiment, the increase gradient kP and the required flow rate Qe are calculated by the lower braking unit SB and transmitted to the upper braking unit SA. Alternatively, the required flow rate Qe or the “increase gradient kP and the required flow rate Qe” may be calculated by the upper braking unit SA. Since signals such as the wheel speed Vw are input to the lower braking unit SB, the determination of the start/end of the ABS control and the calculation of the necessary pressure Po corresponding to each wheel pressure Pw are performed by the lower braking unit SB. However, since the upper and lower braking units SA, SB share signals via the communication bus BS, the calculation is performed as follows. The necessary pressure Po and the increase gradient kP are calculated by the lower braking unit SB, and the required flow rate Qe is calculated by the upper braking unit SA. Alternatively, the necessary pressure Po is calculated by the lower braking unit SB, and the increase gradient kP and the required flow rate Qe are calculated by the upper braking unit SA. Therefore, the increase gradient kP is calculated by either the upper or lower braking unit SA, SB, and the required flow rate Qe is also calculated by either the upper or lower braking unit SA, SB.

In the above embodiment, in the control of the electric motor MA, the target rotation number Nt is calculated, and the actual rotation number Na is controlled based on this target rotation number Nt. There is a correlation between the motor rotation number Na and the supply current Im to the electric motor MA. Therefore, in the control of the electric motor MA, the rotation number Na of the electric motor MA may be controlled by adjusting the motor current Im without calculating the target rotation number Nt. In this configuration, when the ABS control is executed, the motor current Im is increased by a predetermined current im (a constant set in advance) and the motor rotation number Na is increased.

In the above embodiment, a front-rear type is adopted for the braking system including two systems. Alternatively, a diagonal type (also referred to as “X type”) may be adopted for the braking system including two systems. In this configuration, one of the two master chambers Rm is connected to the left front wheel cylinder and the right rear wheel cylinder, and the other of the two master chambers Rm is connected to the right front wheel cylinder and the left rear wheel cylinder. However, in a configuration in which a two-system pressure adjustment is adopted, the braking system is limited to a front-rear type.

In the above embodiment, the tandem type master cylinder CM is exemplified. Alternatively, the single type master cylinder CM may be adopted. In this configuration, the secondary master piston NS is omitted. One master chamber Rm is connected to four wheel cylinders CW. In this configuration, the same supply pressures Pmf, Pmr (=Pm) are output from the master cylinder CM.

In a configuration in which the single-type master cylinder CM is adopted, the master chamber may be connected to the front wheel cylinder CWf, and the pressure adjustment unit CA may be directly connected to the rear wheel cylinder CWr. In this configuration, the front wheel supply pressure Pmf is output from the master cylinder CM to the front wheel cylinder CWf as the front wheel pressure Pwf. On the other hand, the servo pressure Pu is output from the pressure adjustment unit CA to the rear wheel cylinder CWr as the rear wheel supply pressure Pmr.

In the embodiment described above, the pressure receiving area rm (the master area) of the master chamber Rm and the pressure receiving area ru (the servo area) of the servo chamber Ru are set equal to each other in the applying unit AP. The master area rm and the servo area ru do not have to be equal. In a configuration in which the master area rm and the servo area ru are different, a conversion calculation between the supply pressure Pm and the servo pressure Pu can be performed based on a ratio of the servo area ru to the master area rm (that is, the conversion based on “Pm·rm=Pu·ru”).

### Summary of Embodiments

Hereinafter, the embodiments of the braking control device SC will be summarized. The braking control device SC includes the two braking units SA, SB. One is the upper braking unit SA. The upper braking unit SA electrically outputs the supply pressure Pm according to the required braking amount Bs (for example, the braking operation amount Ba and the required deceleration Gs). Specifically, the upper braking unit SA outputs the supply pressure Pm by throttling, with the pressure adjustment valve UA, the circulation flow KN discharged by the fluid pump QA driven by the electric motor MA. The other is the lower braking unit SB provided between the upper braking unit SA and the plurality of wheel cylinders CW. The lower braking unit SB is a general-purpose unit that performs the ABS control and the like. The lower braking unit SB can adjust (increase or decrease) the supply pressure Pm for each of the plurality of wheel cylinders CW individually to output the wheel pressure Pw. Specifically, the lower braking unit SB includes the electric motor MB, the fluid pump QB, and the plurality of solenoid valves (VI, VO, and the like). The lower braking unit SB controls the electric motor MB and the plurality of solenoid valves to adjust the wheel pressure Pw for each wheel cylinder CW. The lower braking unit SB performs the antilock brake control to prevent the wheel lock based on the wheel speed Vw.

In the braking control device SC, when the lower braking unit SB executes the antilock brake control, the upper braking unit SA increases the rotation number Na of the electric motor MA. According to the increase in the motor rotation number Na, the flow rate of the braking liquid BF supplied from the upper braking unit SA to the lower braking unit SB is increased. The lower braking unit SB has a sufficient amount of braking liquid required for executing the ABS control, and therefore performance of the ABS control is improved. Specifically, the increase amount (the actual increase gradient) of the wheel pressure Pw per unit time in the pressurization mode of the ABS control is sufficiently ensured.

In the upper braking unit SA, the increase amount Nz of the motor rotation number Na is determined based on the target increase gradient kP related to the wheel pressure Pw in the antilock brake control. Here, the target increase gradient kP is a target value corresponding to the actual increase gradient of the wheel pressure Pw. The target increase gradient kP is calculated based on the necessary pressure Po (the target value corresponding to the wheel pressure Pw) required for the antilock brake control. By determining the increase amount Nz of the motor rotation number Na based on the target increase gradient kP, the motor rotation number Na is increased to the lowest limit necessary for the execution of the antilock brake control. Accordingly, in addition to improving the performance of the antilock brake control, consumed power of the electric motor MA is decreased.

1. A braking control device for a vehicle, comprising:
an upper braking unit configured to output a supply pressure by throttling, with a pressure adjustment valve, a circulation flow discharged by a fluid pump driven by an electric motor; and
a lower braking unit disposed between the upper braking unit and a wheel cylinder and configured to adjust the supply pressure to output a wheel pressure to the wheel cylinder, wherein
when the lower braking unit executes an antilock brake control, the upper braking unit increases a rotation number of the electric motor.

2. The braking control device for a vehicle according to claim 1, wherein
the upper braking unit determines an increase amount of the rotation number based on an increase gradient of the wheel pressure in the antilock brake control.
